(19) United States
(12) Patent Application Publication
(10) Pub. No.: US 2013/0209096 A1
(43) Pub. Date: Aug. 15, 2013

(54) METHOD FOR CORRECTING A DELAY ASYMMETRY

(71) Applicants: Michel Le Pallec, Nozay (FR); Dinh Thai Bui, Nozay (FR)

(72) Inventors: Michel Le Pallec, Nozay (FR); Dinh Thai Bui, Nozay (FR)

(21) Appl. No.: 13/819,363

(22) PCT Filed: Sep. 15, 2011
(86) PCT No.: PCT/FR2011/052126

§ 371 Date: Apr. 9, 2013

(30) Foreign Application Priority Data
Sep. 20, 2010 (FR) 1003727

(51) Int. Cl. H04J 3/06

(52) U.S. Cl. CPC H04J 3/0635
USPC 398/35

(57) ABSTRACT

Exemplary methods and apparatuses are provided for a method for correcting for a delay asymmetry of synchronization messages transmitted within a packet-switched network between a master clock and a slave clock, in which the delay asymmetry of the path connecting the master clock to the slave clock is determined and corrected locally within at least one link of said path. One or more signals are transmitted on one or more wavelengths over at least one optical fiber. The one or more signals are received and detected on the one or more wavelengths over the at least one optical fiber. The technique determines an arrival time difference between the received and detected one or more signals, and calculates a delay asymmetry of an adjacent link based on the time difference.

The embodiments of the present invention pertain to the field of packet-switched communication networks, and more particularly the distribution of a time reference within those networks.

The constraints imposed by operators, particularly within mobile networks, pertaining to time synchronization, i.e. the distribution of a time reference, are increasingly heavy, which requires optimizing all of the parameters that influence the quality of that time synchronization.

For this reason, in packet-switched networks, one of the main influential parameters is delay asymmetry, which corresponds to a difference in transmission time between a packet transmitted in the master clock-slave clock direction and a packet (with the same sequence number) transmitted in the reverse direction.

In order to reduce this delay asymmetry and approach a time synchronization precision of less than a micro-second as required by operators, one state-of-the-art solution corresponds to offsetting the time difference between the two directions between the master clock and slave clock through the use of an external co-located time reference, generally a global positioning system (GPS).

However, such a solution is very expensive and difficult to implement owing to the number of possible master-slave combinations and the number of parameters that locally influence the transmission (temperature, humidity level, pressure, wavelength, etc.) and that have an effect on the total difference to offset.

It therefore appears necessary to propose a method whose cost is limited, easy to implement, and that makes it possible to offset the delay asymmetry between a master clock and a slave clock. The embodiments of the present invention focus on offsetting the propagation delay asymmetry inherent in links. It should be noted that the described embodiments apply not only to networks using optical fibers, but also in a similar fashion to other transport media, such as over the air with radio transmissions. As a result, the invention is not limited to optical fibers.

Thus, the embodiments of the present invention pertain to a method for correcting for a delay asymmetry of synchronization messages transmitted within a packet-switched network between a master clock and a slave clock, in which the delay asymmetry of the path connecting the master clock to the slave clock is determined and corrected locally within at least one link of said path by means for measuring and correcting a time difference situated within the nodes of the path, said means for measuring being means for measuring the transmission times of signals within said at least one link.

According to another embodiment, the time synchronization of the nodes of the packet-switched network is handled by an IEEE 1588V2 protocol.

According to an additional embodiment, the means for measuring that make it possible to locally determine the delay asymmetry comprise peer-to-peer transparent clocks.

According to an additional embodiment, the means for measuring that make it possible to locally determine the delay asymmetry comprise end-to-end transparent clocks.

According to another embodiment, the means for measuring that enable the local determining of the delay asymmetry comprise boundary clocks.

According to an additional embodiment, the means for measuring that make it possible to locally determine the delay asymmetry (e.g. the determining of the asymmetry of a link adjacent to the node) comprise at least two transmitters (or potentially a single wavelength-tunable optical transmitter), situated within a first node of the link, configured to transmit (simultaneously or with a time difference determined in advance through configuration) two signals at two distinct wavelengths on a single optical fiber and in the same direction, and at least one receiver, situated in a second node of the link, configured to receive and detect said two signals at two distinct wavelengths and to determine the arrival time difference (delay) between the two signals.

According to an additional embodiment, the means for measuring that make it possible to locally determine the delay asymmetry comprise at least two transmitters, situated within a first node of the link, configured to transmit two signals at two distinct wavelengths on two distinct optical fibers and in the same direction and at least one receiver, situated in a second node of the link, configured to receive and detect said two signals at two distinct wavelengths and to determine the arrival time difference between the two signals.

According to another embodiment, transmission and detection are done in the physical layer.

According to an additional embodiment, transmission and detection are done in the packet layer.

According to an additional embodiment, the means for measuring that make it possible to locally determine the delay asymmetry comprise at least one first transmitter-receiver, situated in a first node of the link, configured to transmit a signal on a first wavelength over a first optical fiber and to receive and detect a signal on a second wavelength over the first or a second optical fiber and at least one second transmitter-receiver, situated in a second node of the link, configured to receive and detect the signal transmitted at the first wavelength on the first optical fiber and to loop back to said first node at the second wavelength over the first or second optical fiber, said first transmitter-receiver comprising means for determining the signal's round-trip travel time and means for calculating the delay asymmetry based on said round-trip travel time, on the optical indices associated with the wavelengths carrying signals, on the respective lengths of the fibers, and on environmental parameters (e.g. the temperature).

According to another embodiment, the means for measuring that make it possible to locally determine the delay asymmetry comprise at least one first transmitter-receiver, situated in a first node of the link, configured to transmit a first signal on a first wavelength over a first optical fiber and to receive and detect two signals on a second and a third wavelength over a second optical fiber and a module comprising an optical circulator and a wavelength converter, situated in a second node of the link, configured to retransmit the first signal received at the first wavelength over the first optical fiber to said first node at the second and third wavelength over the second optical fiber, said transmitter-receiver comprising means for determining the signals' round-trip travel time and means for calculating the delay asymmetry based on said travel times, on the optical indices associated with the wavelengths carrying signals, on the respective lengths of the fibers, and on environmental parameters.

According to an additional embodiment, the means for measuring that make it possible to locally determine the delay asymmetry comprise at least one first transmitter-receiver, situated in a first node of the link, configured to transmit a first signal on a first wavelength over a first optical fiber, said first signal being looped back to the first node within a second node of the link by a first optical circulator over said first optical fiber and at least one second transmitter-receiver, situated in a second node of the link, configured to transmit a second signal on a second wavelength over a second optical fiber, said second signal being looped back to the second node within the first node of the link by a second optical circulator over said second optical fiber, said first and second nodes of the link further comprising means for determining round-trip travel times of the first and second signals, respectively, and means for calculating the delay asymmetry based on said round-trip travel times.

According to an additional embodiment, the means for measuring that make it possible to locally determine the delay asymmetry comprise at least two transmitters (TX), situated within a first node of the link, configured to transmit two distinct electromagnetic signals over the same transport medium and in the same direction, and at least one receiver (RX), situated within a second node of the link, configured to receive and detect said two distinct electromagnetic signals and to determine the arrival time difference between the two signals.

According to another embodiment, the means for measuring that make it possible to locally determine the delay asymmetry comprise at least two transmitters (TX), situated within a first node of the link, configured to transmit two distinct electromagnetic signals over two distinct transport media and in the same direction, and at least one receiver (RX), situated within a second node of the link, configured to receive and detect said two distinct electromagnetic signals and to determine the arrival time difference between the two signals.

The embodiments of the present invention further pertain to a packet-switched network comprising means for transmitting (either simultaneously or with a time difference determined in advance through configuration) at least two signals over at least two wavelengths over at least one optical fiber and means for receiving and detecting at least two signals on at least two wavelengths over at least one optical fiber, said node comprising means for determining an arrival time difference between two received and detected signals and means for calculating a delay asymmetry of an adjacent link based on said time difference.

The embodiments of the present invention further pertain to a node of a packet-switched network comprising means for transmitting at least one signal over at least one wavelength over at least one optical fiber and means for receiving and detecting at least one signal on at least one wavelength over at least one optical fiber, said node comprising means for determining a round-trip travel time of the at least one received and detected signal and means for calculating a delay asymmetry of an adjacent link based on said at least one round-trip travel time.

Other characteristics and advantages of the invention will become apparent in the description

that will now be made, with reference to the attached drawings that depict, by way of a non-limiting example, one possible embodiment of it.

In these drawings:

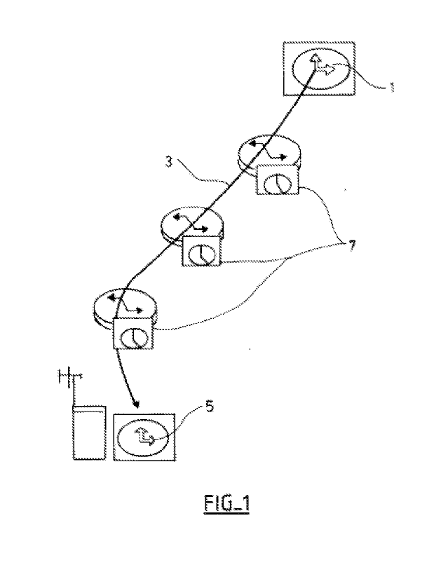

FIG. 1 depicts one portion of the synchronization network, comprising a master clock-slave clock pair, in a diagram where the synchronization on-path support equipments are fully deployed;

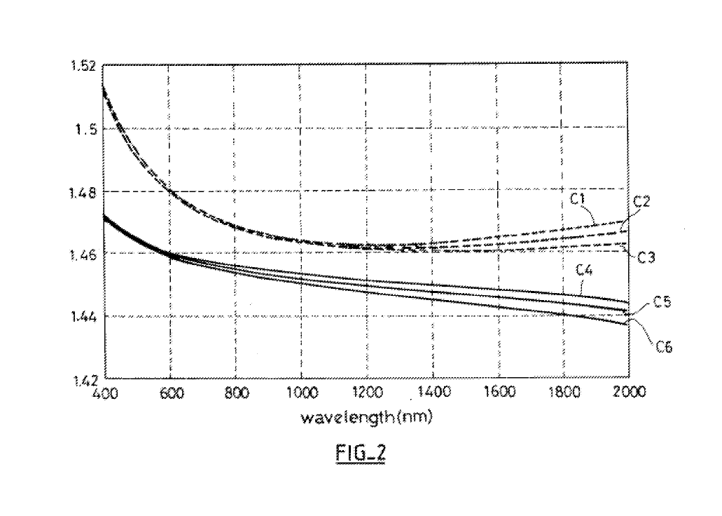

FIG. 2 depicts a graph showing the influence of temperature on the optical fiber propagation index;

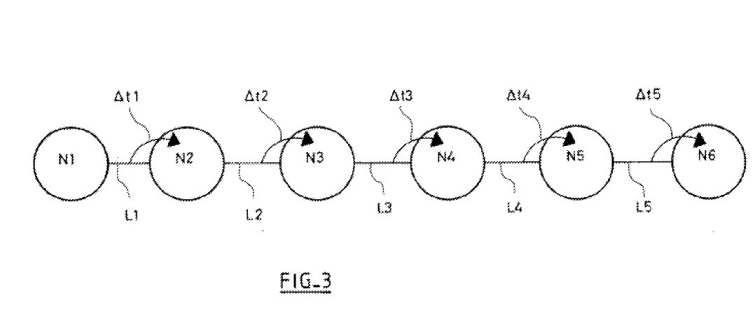

FIG. 3 depicts a diagram of link-by-link delay asymmetry correction, according to the embodiments of the present invention;

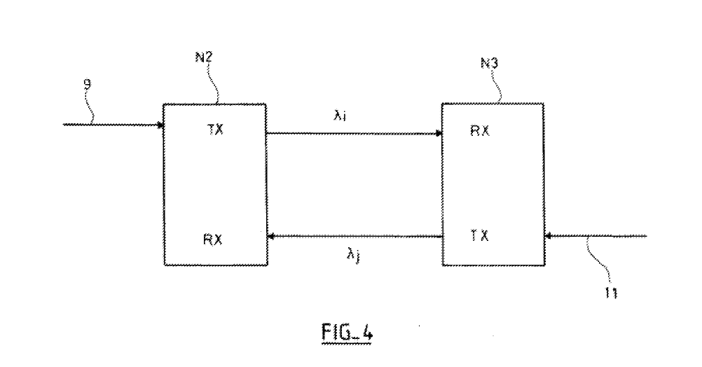

FIG. 4 depicts a diagram in operational mode of the synchronization network, in which the signals are transmitted in one direction over a first fiber at a first wavelength and in the other direction over a second fiber on a second wavelength;

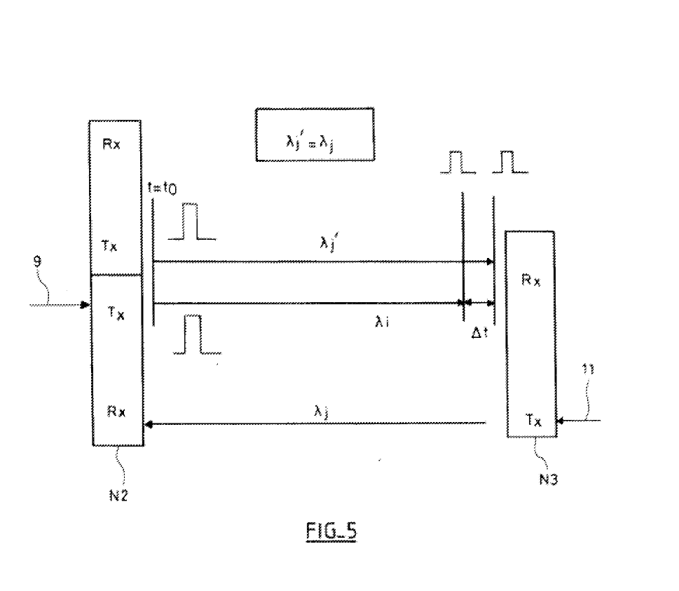

FIG. 5 depicts an example of determining the delay asymmetry of a link according to a first embodiment;

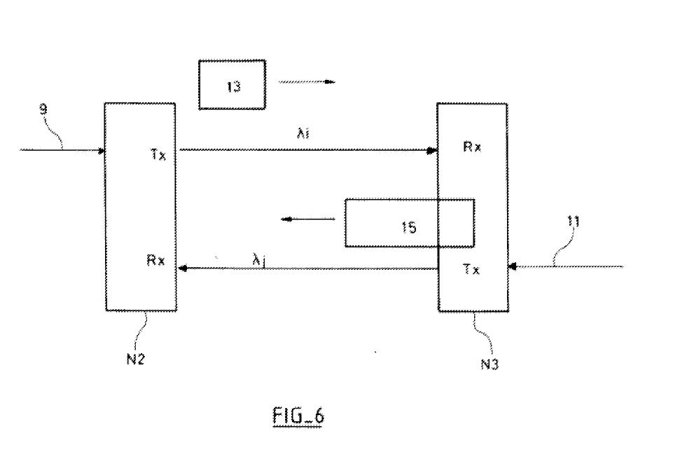

FIG. 6 depicts a diagram in operational mode of a link transmitting messages of the protocol of the IEEE Std 1588Tm-2008 standard (hereafter known as 1588V2) of the Sync type in one direction and of the Delay Req type in the other direction;

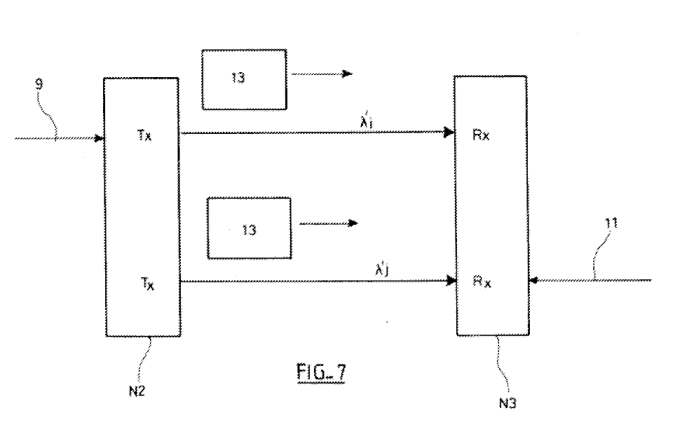

FIG. 7 depicts one example of determining the delay asymmetry of a link according to a second embodiment using messages of the 1588V2 protocol;

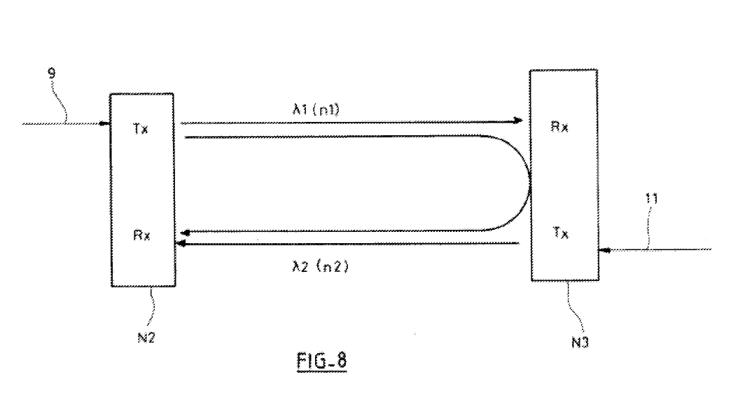

FIG. 8 depicts one example of determining the delay asymmetry of a link according to a third embodiment based on determining the transmission time of a signal on the link's round-trip path;

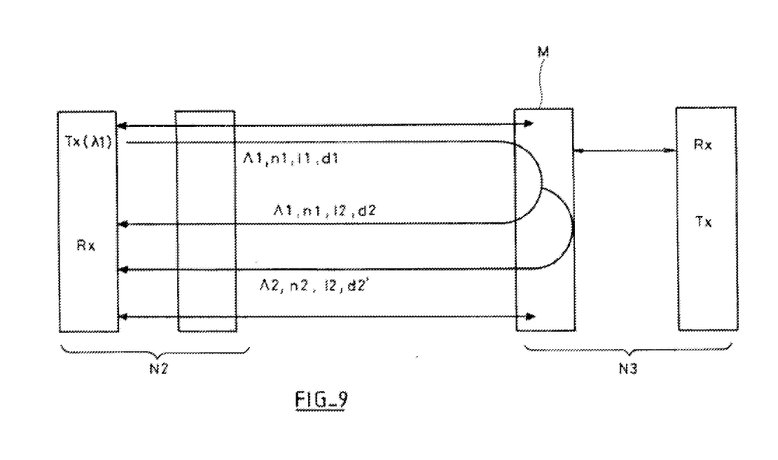

FIG. 9 depicts one example of determining the delay asymmetry of a link according to a fourth embodiment based on determining the transmission time of two signals on the link's round-trip path;

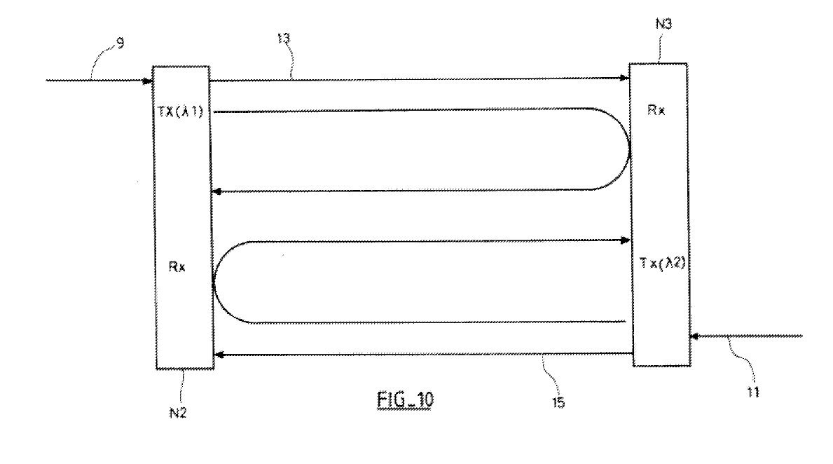

FIG. 10 depicts one example of determining the delay asymmetry of a link according to a fifth embodiment based on determining the transmission time of two signals on two distinct wavelengths on the link's round-trip path;

The remainder of the description refers to the 1588V2 protocol. Nonetheless, it should be noted that other synchronization protocols in a packet-switched network, such as the IETF Network Time Protocol (NTP), may be used in the context of the embodiments of the present invention.

In the following description, generally:

The term “environmental parameter” corresponds to a parameter influencing the transporting of the optical signals that depends on the environment such as temperature or humidity, for example;

The term “end-to-end transparent clock” corresponds to a clock comprising means for determining the transit time of a packet within a network element;

The term “peer-to-peer transparent clock” corresponds to a clock comprising means for determining the transit time of a packet within a network element and the delay of a link adjacent to the node in which the clock is located;

The term “boundary clock” corresponds to a clock that makes it possible to segment the synchronization network into small domains. As a matter of construction, when the boundary clocks are deployed on all the network elements, the boundary clocks comprise means for determining the delay of a link adjacent to the node in which the clock is located;

The term “evolved clock” is used to define an end-to-end transparent, peer-to-peer, transparent or boundary clock;

The term “link” also called “segment” defines the network portion located between two nodes and enabling the transmission of the optical signals, a link generally comprising at least one optical fiber;

The term “IEEE1588V2” corresponds to the acronym “Institute of Electrical and Electronics Engineers 1588 version 2”;

The term “IETF” corresponds to the acronym “Internet Engineering Task Force”;

The term “PTPV2” corresponds to the acronym “Precision Time Protocol version 2”;

The term “CAPEX” stands for “Capital Expenditure” and corresponds to investments in equipment;

The term “OPEX” stands for “Operational Expenditure” and corresponds to operating costs;

The embodiments of the present invention pertain to the determining and correcting of the delay asymmetry of synchronization messages in a diagram in which the synchronization on-path support equipments are fully deployed, meaning one in which each network element comprises an evolved clock of the boundary or end-to-end or peer-to-peer transparent type, said clocks being managed by a single operator. Such a network diagram is depicted in FIG. 1. A master clock 1 distributes a time reference by means of synchronization signals 3 through the network elements, corresponding to network nodes, all the way to a slave clock 6, each intermediary node comprising an evolved clock 7.

Furthermore, the synchronization signals are transmitted through optical fibers particularly comprising silica. However, as FIG. 2 shows, the characteristics of silica vary depending on environmental conditions (here, temperature). Curves c1, c2 and c3 represent the group indices and curves c4, c5 and c6 represent the refraction indexes for respective temperatures of 0, 100, and 200° C. These variations therefore show that the delay asymmetry values may vary over time depending on environmental factors, and therefore that it is necessary to take measurements periodically.

According to the embodiments of the present invention, the delay asymmetry is determined and corrected within each link during the distribution of a frequency reference between the master clock and the slave clock as depicted in FIG. 3. For this reason, the time differences Δt1, Δt2, Δt3, Δt4 and Δt5 respectively corresponding to the delay asymmetry of links L1, L2, L3, L4, and L5 are determined and taken into account locally within the nodes N2, N3, N4, N5 and N6, these (time difference) measurements being periodically taken in order to take into account the variation in environmental parameters and thereby increase the precision and distribution of a time reference.

The network elements that carry out the measurements of the time differences transmit the values of those differences to the elements of the IEEE1588V2 plane, meaning the evolved clocks 7 of the nodes, in order to allow them to make a node-by-node correction of the delay asymmetry caused within each link.

The various embodiments pertaining to the determining of the time differences within the links will now be described in detail.

FIG. 4 depicts a diagram of a link between a node N2 and a node N3 (for example, the nodes N2 and N3 of FIG. 3). The node N2 receives a synchronization message 9 coming from the master clock. That message is then sent by a transmitter TX to the receiver RX of the node N3 through a first optical fiber at a wavelength λi. Conversely, the node N3 receives a synchronization message coming from the slave clock. That message is then sent by a transmitter TX to the receiver RX of the node N2 through the first optical fiber or through a second optical fiber at a wavelength λj. The difference between the wavelengths (and the difference between the lengths, if two fibers are used) causes a delay asymmetry of the link, meaning that the transmission times of the signals in one direction and the other are different.

According to a first embodiment, this asymmetry is determined by simultaneously sending at time t=t0 and in the same direction (from node N2 to node N3, for example a first signal at wavelength λi and a second signal at wavelength λj′ (with λj′=λj) on the same optical fiber and measuring the arrival time difference between the two signals within the receiver RX of the node N3 as depicted in FIG. 5. In order to facilitate detection within the receiver RX of the node N3, the signals may be, for example slot signals (i.e. pulses) that can easily be detected as they rise, and make it possible to precisely determine the moment of reception. For this reason, the time difference Δt makes it possible to get a good estimate of the delay asymmetry of the synchronization link between the nodes N2 and N3. In that first case, the detecting of the signals is therefore done directly within the physical layer. If it is not feasible to send the signals simultaneously, it is possible to send them with a time difference controlled and configured by the operator. This time difference shall be deduced from the delay Δt obtained when the signals are received.

In the context of a network managed by an IEEE1588V2 protocol, the messages exchanged between the nodes comprise PTPV2 packets. These packets are Sync messages 13 in the Master-Slave direction and Delay Req messages 15 in the Slave-Master direction as depicted in FIG. 6. Because of the differences in optical indices owing to the difference in wavelengths (between λi and λj), a delay asymmetry is introduced. Thus, according to a second embodiment depicted in FIG. 7, two Sync signals 13 are transmitted simultaneously from the node N2 to the node N3 at wavelengths λi′ and λj′ close to wavelength λi and λj of the Sync and Delay Req messages for which the delay asymmetry is to be estimated. As before, the propagation time difference Δt′ between the two messages transmitted at the wavelengths λi′ and λj′ is measured. The time difference Δt between the messages transmitted at the wavelengths λi and λj is then deduced from Δt′. The following demonstration is given as an example. This demonstration applies if there is only one optical fiber or two optical fibers of identical lengths l. Generally speaking, this embodiment applies to two fibers of different lengths, which embodiment makes it possible to also achieve the delay asymmetry inherent in difference in length of the optical fibers.

Now assuming for the following demonstration a single optical fiber with length l for both propagation directions of the IEEE1588V2 messages,

the average delay d over a wavelength λi may be defined by

$$d ( {λ}_{i} ) = \frac{l \cdot {n}_{i}}{c}$$

where l is the length of the fiber, nᵢ is the optimal propagation index related to the wavelength λi, and c is the speed of light in a vacuum.

Likewise

$$d ( {λ}_{j} ) = \frac{l \cdot {n}_{j}}{c}$$

Thus,

$$Δ t = \frac{l \cdot \vert {n}_{i} - {n}_{j} \vert}{c}$$

and therefore

$${Δ}^{′} t = \frac{l \cdot \vert {n}_{t}^{′} - {n}_{j}^{′} \vert}{c}$$

the result is

$$Δ t = \frac{\vert {n}_{i} - {n}_{j} \vert}{\vert {n}_{i}^{′} - {n}_{j}^{′} \vert} Δ {t}^{′}$$

Δt may therefore be deduced from Δt′ and from the different optical propagation indices. The wavelengths λi′ and λj′ may be reserved or dedicated to determining the delay asymmetry or control wavelengths. Additionally, out of a desire to optimize resources, the measurements may be taken in the opposite direction if that direction is less in-demand in terms of bandwidth.

It should also be noted that for this embodiment, the clocks must be capable of generating event messages such as Sync messages. This function may be carried out by generating in advance and manually Sync messages that are then saved in a specific location of the clock's memory. This avoids the complex implementation of the 1588V2 protocol stack (also called PTPV2). In this second case, the transmission and detection of signals is carried out within the packet layer.

According to a third embodiment depicted in FIG. 8, a delay measurement is taken on a signal performing a round-trip path between two nodes, the outgoing path being traveled at a first wavelength λ1 corresponding to a first optical index n1 and the return being traveled on a second wavelength λ2 corresponding to a second optical index n2. In order to determine the delay asymmetry based on the round-trip travel time, it is necessary for the transmission distance to be the same in both directions. This means that this embodiment chiefly applies in situations where both the outgoing and return paths take place over the same optical fiber. It is also necessary to precisely know the optical indices n1 and n2 because the precision of determining the delay asymmetry depends on those indices.

This is because the outgoing travel time, abbreviated d1, may be defined by:

$$d 1 = ( \frac{n 1}{n 1 + n 2} ) * RIT ,$$

where RTT is the round-trip travel time,
and the return travel time by:

$$d 2 = ( \frac{n 2}{n 1 + n 2} ) * RIT$$

The delay asymmetry (d1−d2) may then be deduced.

$$d 1 - d 2 = ( \frac{n 1 - n 2}{n 1 + n 2} ) * RIT$$

It should be noted that if the second node (N3) cannot instantly loop back the received signal, a mechanism for correcting the node's transit delay, as present in the transparent clocks (peer-to-peer or end-to-end) must be applied in order to offset the delay introduced by that looping back. Additionally, that second node (N3) must be capable of performing a wavelength conversion (from λ1 to λ2).

In order to extend it to the use of multiple optical fibers by using round-trip travel time measurements, a fourth embodiment is depicted in FIG. 9. A signal on a first wavelength λ1 is transmitted by the node N2 over a first optical fiber to the node N3. Within the node N3 the signal is looped back to the node N2 on a second and third wavelength over a second optical fiber (in the present case, the first and second wavelengths are identical and are denoted λ1, the third wavelength being denoted λ2).

The looping back of the signals is done within a module M comprising an optical circulator and a wavelength converter, the module M being located a close or known distance away from the receivers Rx and transmitters Tx of the node N3.

The round-trip travel times RTT1 and RTT2, corresponding to the two signals received by the node N2, may be described by the following equations:

$$RIT 1 = \frac{n 1 * 11}{c} + \frac{n 1 * 12}{c} and RIT 2 = \frac{n 1 * 11}{c} + \frac{n 2 * 12}{c}$$

where n1 and n2 are the respective optical indices corresponding to the wavelengths λ1 and λ2, and l1 and l2 are the respective wavelengths of the first and second optical fibers.

The lengths and travel times that correspond to the optical fibers may then be determined and the delay asymmetry deduced. Furthermore, in this embodiment, the two optical fibers are considered to have identical (or very close) physical characteristics, meaning that on a given wavelength, they have the same optical index (or a very close optical index).

According to a fifth embodiment depicted in FIG. 10, first, a first signal is transmitted by a first node N2 at a first wavelength λ1 over a first optical fiber to a second node N3, then looped back to the first node N2 at the same first wavelength and over the same first optical fiber, and second, a second signal is transmitted by the second node N3 on a second wavelength λ2 over a second optical fiber to the first node N2 then looped back to the second node N3 at the same wavelength and over the same second optical fiber. In this way, two round-trip travel times RTT1 and RTT2 are measured. The delay asymmetry d (between a Sync message 13 transmitted at a wavelength λ1 and a Delay Req message 15 transmitted at a wavelength λ2) may then be calculated:

$$d = \frac{RIT 1 - RIT 2}{2}$$

It should be noted that for the calculation of d to be possible and consistent with the concept diagram of link-by-link delay asymmetry correction described by FIG. 3, RTT1 and RTT2 must be available within the node ensuring the calculation of d. From that point, either one of the values RTT1 or RTT2 must be transmitted to the adjacent node, preferentially by a so-called “packet” method.

Thus, the embodiments of the present invention describe a determining of the delay asymmetry, locally within the links of the path, by finding the difference in measurements of instants representative of signals exchanged between the two nodes of the link, those signals potentially being transmitted within the physical layer or the packet layer.

Additionally, these measurements correspond to measuring the time difference using a single clock located in one of the two nodes of the link. This particularly applies to transparent clocks, for which there is no time synchronization shared between two transparent clocks, such that the delay asymmetry cannot be determined using the two clocks of the link's two nodes.

Additionally, examining the time synchronization of the Master and Slave clock by the IEEE 1588V2 protocol, the knowledge of the correction of the determined link delay asymmetry is carried only by Sync signals, meaning signals transmitted from the master clock to the slave clock, such that the Delay_Req messages transmitted from the slave clock to the master clock do not undergo any changes, which makes it possible to simplify the implementation of a correction of the delay asymmetry in accordance with the embodiments of the present invention in the case of a network comprising a multi-broadcast capacity.

Furthermore, the mechanisms of the embodiments previously described can be managed within the network elements and may be automatically and remotely controlled by a management entity of the network.

Nonetheless, alternatively, said mechanisms may also be managed within the control plane thanks to the use of specific exchange messages between the various network elements in order to schedule, trigger, and control the delay asymmetry measurements within the links. This management may be supported by the synchronization plane owing to the exchanging of IEEE1588V2 messages comprising an additional dedicated Type Length Value (TLV) extension.

Thus, the embodiments of the present invention make it possible, by determining the delay asymmetry within each link of the path between the master clock and the slave clock and by correcting that delay asymmetry within each node of the path, to improve the quality (meaning the precision) of the distribution of the time within the network in order to move towards compliance with the constraints imposed by operators without requiring heavy investment or operating costs (CAPEX and OPEX). Additionally, the implementation of the various presented embodiments is easy to implement and control, as it can be automatically managed on the network level and makes it possible to take regular measurements in order to take into account variations in environmental parameters.

The embodiments are applicable to radio frequency transmissions with several nuances of language and complexity. This is because for such a case, the transport medium is as a first approximation the same in both signal propagation directions, and is analogous to the embodiments that assume a single optical fiber (a single transport medium). Furthermore, for such a medium (the air), the electromagnetic signals are preferentially described in terms of frequency rather than in terms of wavelength.

1. A method for correcting for a delay asymmetry of synchronization messages transmitted within a packet-switched network between a master clock and a slave clock, the method comprising:
locally determining and correcting the delay asymmetry of a path that connects the master clock to the slave clock within at least one link of said path;
measuring and correcting a time difference situated within nodes of the path; and
measuring transmission times of signals within said at least one link.

2. The method according to claim 1, wherein a time synchronization of the nodes of the packet-switched network is handled by an Institute of Electrical and Electronics Engineers 1588 version 2 (IEEE 1588V2) protocol.

3. The method according to claim 2, wherein peer-to-peer transparent clocks are used to locally determine the delay asymmetry.

4. The method according to claim 2, wherein end-to-end transparent clocks are used to locally determine the delay asymmetry.

5. The method according to claim 2, wherein boundary clocks are used to locally determine the delay asymmetry.

6. The method according to claim 1, further comprising locally determining the delay asymmetry via
at least two transmitters situated within a first node of the at least one link and configured to transmit two signals at two distinct wavelengths on a single optical fiber and in a same direction, and
at least one receiver situated in a second node of the at least one link and configured to receive and detect said two signals at said two distinct wavelengths and to determine an arrival time difference between said two signals.

7. The method according to claim 1, further comprising locally determining the delay asymmetry via
at least two transmitters situated within a first node of the at least one link and configured to transmit two signals at two distinct wavelengths on two distinct optical fibers and in a same direction; and
at least one receiver situated in a second node of the at least one link and configured to receive and detect said two signals at said two distinct wavelengths and to determine an arrival time difference between said two signals.

8. The method according to claim 6, wherein transmission and detection are performed in a physical layer.

9. The method according to claim 6, wherein transmission and detection are performed in a packet layer.

10. The method according to claim 1, further comprising locally determining the delay asymmetry via
at least one first transmitter-receiver situated in a first node of the at least one link and configured to transmit a signal at a first wavelength over a first optical fiber and to receive and detect a signal on a second wavelength over the first optical fiber or a second optical fiber; and
at least one second transmitter-receiver situated in a second node of the at least one link and configured to receive and detect the signal transmitted at the first wavelength on the first optical fiber and to loop back to said first node at the second wavelength over the first optical fiber or second optical fiber, said first transmitter-receiver being configured to determine the signal's round-trip travel time and to calculate the delay asymmetry based on said round-trip travel time, on the optical indices associated with the wavelengths carrying signals, on the respective lengths of the fibers, and on environmental parameters.

11. The method according to claim 1, further comprising locally determining the delay asymmetry via
at least one first transmitter-receiver situated in a first node of the at least one link and configured to transmit a first signal at a first wavelength over a first optical fiber and to receive and detect two signals on a second and a third wavelength over a second optical fiber; and
a module comprising an optical circulator and a wavelength converter situated in a second node of the link and configured to retransmit the first signal received at the first wavelength over the first optical fiber to said first node at the second and third wavelength over the second optical fiber;
wherein said transmitter-receiver is configured to determine the signals' round-trip travel time and to calculate the delay asymmetry based on said travel times, on the optical indices associated with the wavelengths carrying signals, on the respective lengths of the fibers, and on environmental parameters.

12. The method according to claim 1, further comprising locally determining the delay asymmetry via
at least one first transmitter-receiver situated in a first node of the at least one link and configured to transmit a first signal at a first wavelength over a first optical fiber, said first signal being looped back to the first node within a second node of the at least one link by a first optical circulator over said first optical fiber; and
at least one second transmitter-receiver situated in a second node of the at least one link and configured to transmit a second signal on a second wavelength over a second optical fiber, said second signal being looped back to the second node within the first node of the at least one link by a second optical circulator over said second optical fiber, said first and second nodes of the at least one link being configured to determine round-trip travel times of the first and second signals, respectively, and to calculate the delay asymmetry based on said round-trip travel times.

13. The method according to claim 1, further comprising locally determining the delay asymmetry via
at least two transmitters situated within a first node of the at least one link and configured to transmit two distinct electromagnetic signals over a same transport medium and in the same direction; and
at least one receiver situated within a second node of the at least one link and configured to receive and detect said two distinct electromagnetic signals and to determine an arrival time difference between said two distinct electromagnetic signals.

14. The method according to claim 1, further comprising locally determining the delay asymmetry via
at least two transmitters situated within a first node of the at least one link and configured to transmit two distinct electromagnetic signals over two distinct transport media and in a same direction; and
at least one receiver situated within a second node of the at least one link and configured to receive and detect said two distinct electromagnetic signals and to determine an arrival time difference between said two distinct electromagnetic signals.

15. A node of a packet-switched network, comprising:
means for transmitting at least two signals on at least two wavelengths over at least one optical fiber;
means for receiving and detecting said at least two signals on said at least two wavelengths over said at least one optical fiber;
means for determining an arrival time difference between two received and detected signals; and
means for calculating a delay asymmetry of an adjacent link based on said time difference.

16. A node of a packet-switched network, comprising:
means for transmitting at least one signal on at least two wavelengths over at least one optical fiber;
means for receiving and detecting said at least one signal on said at least two wavelengths over said at least one optical fiber;
means for determining a round-trip travel time of the at least one received and detected signal; and
means for calculating a delay asymmetry of an adjacent link based on said at least one round-trip travel time.
